(19) United States
(12) Patent Application Publication
(10) Pub. No.: US 2026/0012234 A1
(43) Pub. Date: Jan. 8, 2026

(54) ADAPTIVE SUB-BAND EIGEN PRECODING

(71) Applicant: Samsung Electronics Co., Ltd., Suwon-si (KR)

(72) Inventors: Rajesh Kumar Mishra, Dallas, TX (US); R A Nadisanka Perera Rupasinghe, McKinney, TX (US); Yang Li, Plano, TX (US)

(21) Appl. No.: 19/084,735

(22) Filed: Mar. 19, 2025

Related U.S. Application Data
(60) Provisional application No. 63/667,607, filed on Jul. 3, 2024.

(51) Int. Cl. H04B 7/0456; H04B 7/0452

(52) U.S. Cl. CPC H04B 7/0456; H04B 7/0452

(57) ABSTRACT

When determining precoding for UEs classified as falling within an intermediate range of uplink signal-to-noise ratio, for which precoding performance is improvable by wideband channel computations of eigen vectors for a channel representation or signal-to-leakage-and-noise ratio (SLNR), the precoding scheme is adapted based at least in part on how the UE is classified. For multiple user operation with other UEs, the precoding scheme orthogonalizes precoder subspaces of each subset of UEs by zero forcing precoding. The precoding scheme for the intermediate range UEs may be an adaptive sub-band eigen precoding scheme that reduces interference caused by a transmission of the UE with reception by other UEs. The precoding scheme for the intermediate range UEs may alternatively optimize SLNR for transmission of the UE relative to transmissions other UEs.

### CROSS-REFERENCE TO RELATED AND CLAIM OF PRIORITY

The present application claims priority under 35 U.S.C. § 119 (e) to U.S. Provisional Patent Application No. 63/667,607 filed on Jul. 3, 2024, which is hereby incorporated by reference in its entirety.

### TECHNICAL FIELD

The present disclosure relates generally to precoding for different categories of UEs based on classification and, more specifically, to precoding for UEs in an intermediate range of sounding reference signal signal-to-noise ratio.

### BACKGROUND

Wireless communication has been one of the most successful innovations in modern history. Recently, the number of subscribers to wireless communication services exceeded five billion and continues to grow quickly. The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage are of paramount importance. To meet the demand for wireless data traffic having increased since deployment of 4G communication systems, and to enable various vertical applications, 5G communication systems have been developed and are currently being deployed.

### SUMMARY

The present disclosure relates to precoding for UEs classified as falling within an intermediate range of uplink signal-to-noise ratio.

In a first embodiment, a method includes determining when uplink (UL) channel quality for a channel for a user equipment (UE) is in an intermediate sounding reference signal (SRS) signal-to-noise ratio (SNR) range that is greater than a first SRS SNR threshold and less than a second SRS SNR threshold. The precoding performance for the UE having an intermediate SRS SNR is improvable by wideband channel computations of at least one of eigen vectors for a channel representation or signal-to-leakage-and-noise ratio (SLNR) for a channel. The method also includes providing, to the UE, a precoding scheme adapting precoding performance for the UE based at least in part on how the UE is classified, when the UL channel quality is in the intermediate SNR range instead of within a range above the second SRS SNR threshold or a range below the first SRS SNR threshold.

Any single one or any combination of the following features may be used with the first embodiment. A precoding scheme may be provided by indicating, to the UE, precoders for multiple user (MU) operation of the UE with other UEs that orthogonalize precoder subspaces of each subset of UEs within the range above the second SRS SNR threshold, within the intermediate range, or within the range below the first SRS SNR threshold. The precoder subspaces may be orthogonalized by zero forcing (ZF) precoding. The precoding scheme adapting precoding performance for the UE may include a sub-band eigen precoding scheme that reduces interference caused by a transmission of the UE with reception by other UEs. The sub-band eigen precoding scheme may be an adaptive sub-band eigen precoding scheme. The precoding scheme adapting precoding performance for the UE may include an SLNR precoding scheme optimizing SLNR for transmission of the UE relative to transmissions other UEs. A precoder determined based on the SLNR precoding scheme may be combined with zero forcing (ZF) precoders for UEs within the range above the second SRS SNR threshold and ZF precoders for UEs within the range below the first SRS SNR threshold.

In a second embodiment, a base station apparatus in a communication system includes a transceiver configured to receive sounding reference signals (SRSs) from a plurality of UEs served by the base station. The base station apparatus also includes at least one processing device coupled to the transceiver. The at least one processing device is configured to determine when uplink (UL) channel quality for a channel for a user equipment (UE) is in an intermediate sounding reference signal (SRS) signal-to-noise ratio (SNR) range that is greater than a first SRS SNR threshold and less than a second SRS SNR threshold. The precoding performance for the UE having an intermediate SRS SNR is improvable by wideband channel computations of at least one of eigen vectors for a channel representation or signal-to-leakage-and-noise ratio (SLNR) for a channel. The at least one processing device is also configured to provide a precoding scheme adapting precoding performance for the UE based at least in part on how the UE is classified, when the UL channel quality is in the intermediate SNR range instead of within a range above the second SRS SNR threshold or a range below the first SRS SNR threshold.

Any single one or any combination of the following features may be used with the second embodiment. A precoding scheme may be provided by indicating, to the UE, precoders for multiple user (MU) operation of the UE with other UEs that orthogonalize precoder subspaces of each subset of UEs within the range above the second SRS SNR threshold, within the intermediate range, or within the range below the first SRS SNR threshold. The precoder subspaces may be orthogonalized by zero forcing (ZF) precoding. The precoding scheme adapting precoding performance for the UE may include a sub-band eigen precoding scheme that reduces interference caused by a transmission of the UE with reception by other UEs. The sub-band eigen precoding scheme may be an adaptive sub-band eigen precoding scheme. The precoding scheme adapting precoding performance for the UE may include an SLNR precoding scheme optimizing SLNR for transmission of the UE relative to transmissions other UEs. A precoder determined based on the SLNR precoding scheme may be combined with zero forcing (ZF) precoders for UEs within the range above the second SRS SNR threshold and ZF precoders for UEs within the range below the first SRS SNR threshold.

In a third embodiment, a UE apparatus in a communication system includes a transceiver configured to transmit sounding reference signals (SRSs) to a base station serving a plurality of UEs. The UE apparatus also includes at least one processing device coupled to the transceiver. The at least one processing device is configured to receive, from the base station, an indication of a precoding scheme. When uplink (UL) channel quality for a channel for the UE is in an intermediate sounding reference signal (SRS) signal-to-noise ratio (SNR) range that is greater than a first SRS SNR threshold and less than a second SRS SNR threshold, precoding performance for the UE is improvable by wideband channel computations of at least one of eigen vectors for a channel representation or signal-to-leakage-and-noise ratio (SLNR) for a channel. The precoding scheme provided to the UE apparatus adapts precoding performance for the UE based at least in part on how the UE is classified, when the UL channel quality is in the intermediate SNR range instead of within a range above the second SRS SNR threshold or a range below the first SRS SNR threshold.

Any single one or any combination of the following features may be used with the third embodiment. A precoding scheme may be provided by indicating, to the UE, precoders for multiple user (MU) operation of the UE with other UEs that orthogonalize precoder subspaces of each subset of UEs within the range above the second SRS SNR threshold, within the intermediate range, or within the range below the first SRS SNR threshold. The precoder subspaces may be orthogonalized by zero forcing (ZF) precoding. The precoding scheme adapting precoding performance for the UE may include a sub-band eigen precoding scheme that reduces interference caused by a transmission of the UE with reception by other UEs. The sub-band eigen precoding scheme may be an adaptive sub-band eigen precoding scheme. The precoding scheme adapting precoding performance for the UE may include an SLNR precoding scheme optimizing SLNR for transmission of the UE relative to transmissions other UEs. A precoder determined based on the SLNR precoding scheme may be combined with zero forcing (ZF) precoders for UEs within the range above the second SRS SNR threshold and ZF precoders for UEs within the range below the first SRS SNR threshold.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network 100 within which adaptive precoding may be implemented according to embodiments of the present disclosure;

FIG. 2 illustrates an example gNB 102 within which adaptive precoding may be implemented according to embodiments of the present disclosure;

FIG. 3 illustrates an example UE 116 within which adaptive precoding may be implemented according to embodiments of the present disclosure;

FIG. 4A and FIG. 4B illustrate an example of wireless transmit and receive paths, respectively, within the gNB of FIG. 2 and/or the UE of FIG. 3;

FIG. 5 illustrates a flowchart of an example procedure for adaptive precoding according to embodiments of the present disclosure;

FIG. 6 is a block diagram of a multi-user subspace precoding architecture for use with adaptive sub-band eigen precoding according to embodiments of the present disclosure;

FIG. 7 is a block diagram of multi-user precoder architecture demonstrating the preprocessing of CSI of intermediate SRS SNR users, with subsequent use of the pre-processed CSI for generating precoders, according to embodiments of the present disclosure;

FIG. 8 is a block diagram of an alternative multi-user precoder architecture demonstrating the preprocessing of CSI of intermediate SRS SNR users, with subsequent use of the pre-processed CSI for generating precoders, according to embodiments of the present disclosure;

FIG. 9 is a block diagram of a multi-user precoder architecture using SLNR maximization optimization of the medium SRS SNR users, and then sending the resulting precoders as CSI to the ZF precoder, according to embodiments of the present disclosure; and

FIG. 10 is a block diagram of an alternative multi-user precoder architecture using SLNR maximization optimization of the medium SRS SNR users, and then sending the resulting precoders as CSI to the ZF precoder, according to embodiments of the present disclosure.

### DETAILED DESCRIPTION

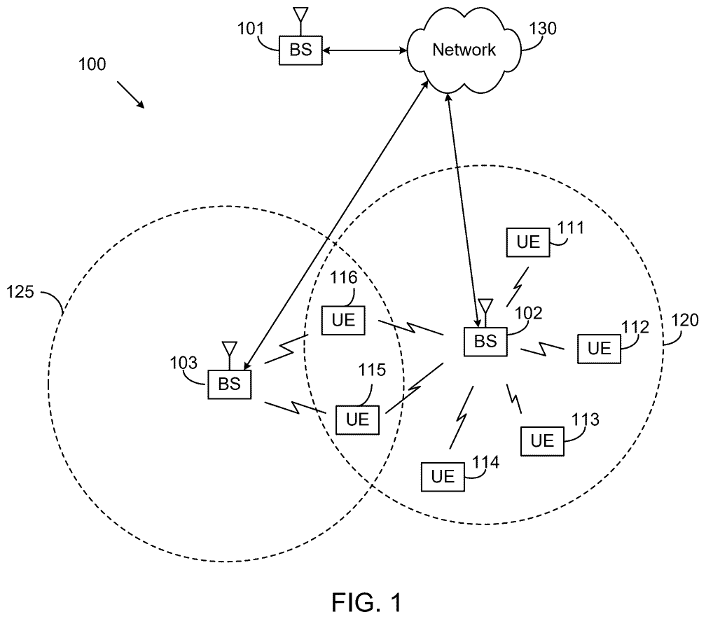

FIGS. 1-10, discussed below, and the various, non-limiting embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

The following documents and standards descriptions are hereby incorporated by reference into the present disclosure as if fully set forth herein:
[1] B. Ghojogh, F Karray, and M. Crowley, ‘Eigenvalue and Generalized Eigenvalue Problems: Tutorial’, arXiv, May 2022
[2] Andre Tkacenko, P. P. Vaidyanathan, and Truong Q. Nguyen, ‘On the Eigenfilter Design Method and Its Applications: A Tutorial’, IEEE Trans. Analog & Digital Sig. Proc., September 2003
[3] A. Eremenko, “Simultaneous diagonalization of two quadratic forms and a generalized eigenvalue problem”, Perdue University, April 2020
[4] 3GPP TS 36.211 v16.4.0, “E-UTRA, Physical channels and modulation.”
[5] 3GPP TS 36.212 v16.4.0, “E-UTRA, Multiplexing and Channel coding.”
[6] 3GPP TS 36.213 v16.4.0, “E-UTRA, Physical Layer Procedures.”
[7] 3GPP TS 36.321 v16.3.0, “E-UTRA, Medium Access Control (MAC) protocol specification.”
[8] 3GPP TS 36.331 v16.3.0, “E-UTRA, Radio Resource Control (RRC) Protocol Specification.”
[9] 3GPP TS 38.211 v16.4.0, “NR, Physical channels and modulation.”
[10] 3GPP TS 38.212 v16.4.0, “NR, Multiplexing and Channel coding.”
[11] 3GPP TS 38.213 v16.4.0, “NR, Physical Layer Procedures for Control.”
[12] 3GPP TS 38.214 v16.4.0, “NR, Physical Layer Procedures for Data.”
[13] 3GPP TS 38.215 v16.4.0, “NR, Physical Layer Measurements.”
[14] 3GPP TS 38.321 v16.3.0, “NR, Medium Access Control (MAC) protocol specification.”
[15] 3GPP TS 38.331 v16.3.1, “NR, Radio Resource Control (RRC) Protocol Specification.”

The following abbreviations are used herein:

| | |
|---|---|
| CSI | Channel State Information |
| CSI-RS | Channel State Information Reference Signal |
| dB | decibel |
| DL | Downlink |
| FDD | Frequency Division Duplexing |
| FDM | Frequency Division Multiplexing |
| MIMO | Multi-input multi-output |
| MU-MIMO | Multi-user MIMO |
| NR | New Radio |
| NW | Network |
| PRB | Physical Resource Block |
| PMI | Precoding matrix indicator |
| RAT | Radio access technology |
| RB | Resource Block |
| RBG | Resource Block Group |
| RE | Resource Element |
| RRC | Radio Resource Control |
| RRH | Remote Radio Head |
| RS | Reference Signals |
| SF | Subframe |
| SRS | Sounding Reference Signal |
| TDD | Time Division Duplexing |
| UE | User Equipment |
| UL | Uplink |

To reap the maximum benefits from 3^{rd} Generation Partnership Project (3GPP) 5^{th} Generation (5G) NR systems, MU-MIMO transmission is important at all UL signal-to-noise ratios (SNRs). Current implementations employ has different precoding techniques for high and low SNR users. However, at intermediate UL SNRs, there is a scope to further improve performance by employing a different precoding technique.

The present disclosure can include an adaptive technique that segregates the medium UL SNR users and then uses a wideband precoding technique to obtain the precoders for those users.

This technique complies with the current implementation of the precoding technique and can prove to be beneficial in the on-field operations.

This disclosure describes an adaptive sub-band eigen precoding scheme which can perform better than SRS-based RB/RBG level and PMI-based precoding when UL channel quality is neither too high nor too low.

An adaptive sub-band eigen precoding scheme configured to perform better than SRS-based RB/RBG level and wideband-PMI-based precoding is provided when UL channel quality is in an intermediate SNR range that is greater than certain lower threshold and lesser than a certain SRS SNR threshold.

A user that benefits from wideband averaging of channels is classified accordingly, and then the classification of the user with other users is employed in a MU scenario to improve the user's performance and interference caused to the other users.

An architectural framework is provided to compute particular precoders in a MU scenario with the other users based on precoding methods while orthogonalizing precoder subspaces of each subset of users.

Although the focus of the description below is on 3GPP 5G NR communication systems, various embodiments may apply in general to UEs operating with other RATs and/or standards, including without limitation different releases/generations of 3GPP standards (such as beyond 5G, 6G, and so on) and IEEE standards (such as 802.16 WiMAX and 802.11 Wi-Fi).

FIGS. 1-4 below describe various embodiments implemented in wireless communications systems and with the use of orthogonal frequency division multiplexing (OFDM) or orthogonal frequency division multiple access (OFDMA) communication techniques. The descriptions of FIGS. 1-4 are not meant to imply physical or architectural limitations to how different embodiments may be implemented. Different embodiments of the present disclosure may be implemented in any suitably arranged communications system.

FIG. 1 illustrates an example wireless network 100 within which adaptive precoding may be implemented according to embodiments of the present disclosure. The embodiment of the wireless network 100 shown in FIG. 1 is for illustration only. Other embodiments of the wireless network 100 could be used without departing from the scope of this disclosure.

As shown in FIG. 1, the wireless network 100 includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3^{rd} generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

The dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof for decoding of low-density parity check codes. In certain embodiments, one or more of the BSs 101-103 include circuitry, programing, or a combination thereof to support adaptive precoding.

Although FIG. 1 illustrates one example of a wireless network, various changes may be made to FIG. 1. For example, the wireless network 100 could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

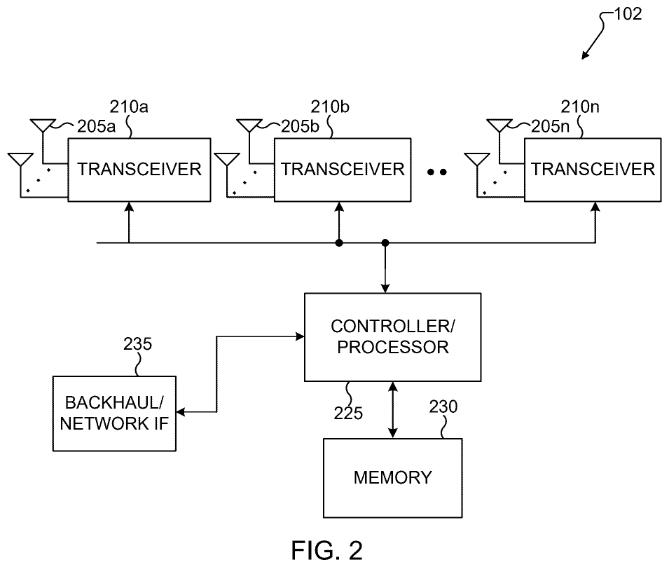

FIG. 2 illustrates an example gNB 102 within which adaptive precoding may be implemented according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of this disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming radio frequency (RF) signals, such as signals transmitted by UEs in the wireless network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the gNB 102. For example, the controller/processor 225 could control the reception of uplink (UL) channel signals and the transmission of downlink (DL) channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. As another example, the controller/processor 225 could support methods for beam management in JPTA system with multiple component carriers. Any of a wide variety of other functions could be supported in the gNB 102 by the controller/processor 225.

The controller/processor 225 is also capable of executing programs and other processes resident in the memory 230, such as processes to trigger beam management in JPTA system with multiple component carriers. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a cellular communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

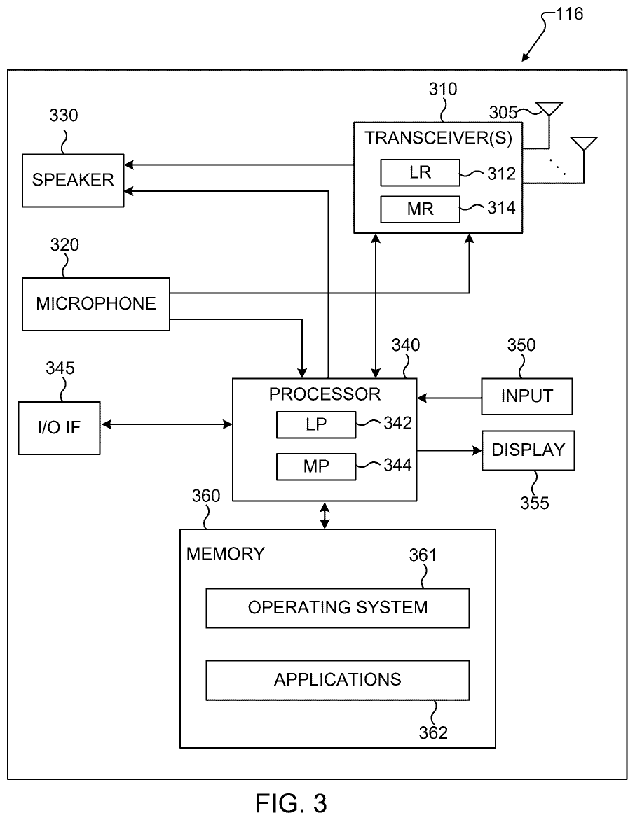

FIG. 3 illustrates an example UE 116 within which adaptive precoding may be implemented according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives from the antenna(s) 305, an incoming RF signal transmitted by a gNB of the wireless network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360. For example, the processor 340 may execute processes for beam management in JPTA system with multiple component carriers as described in embodiments of the present disclosure. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes, for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

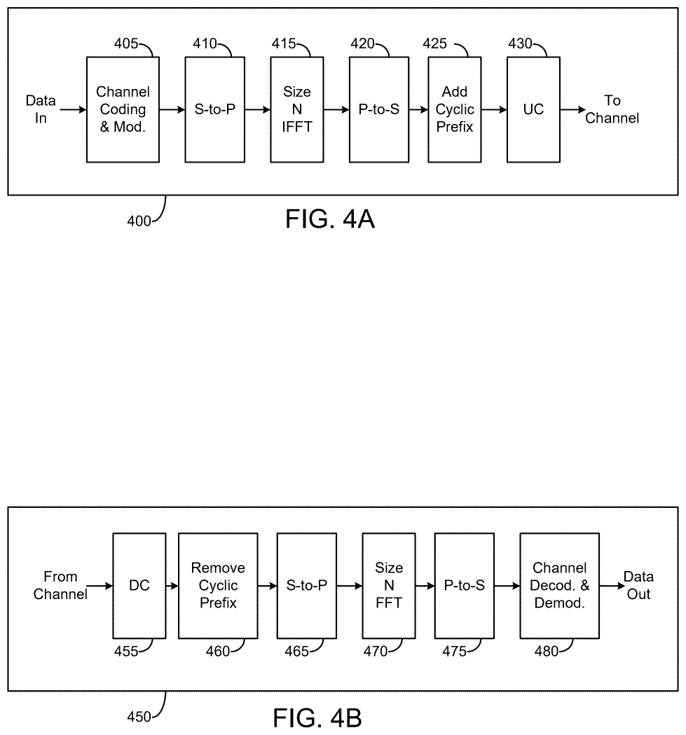

FIG. 4A and FIG. 4B illustrate an example of wireless transmit and receive paths 400 and 450, respectively, according to embodiments of the present disclosure. For example, a transmit path 400 may be described as being implemented in a gNB (such as gNB 102), while a receive path 450 may be described as being implemented in a UE (such as UE 116). However, it will be understood that the receive path 450 can be implemented in a gNB and that the transmit path 400 can be implemented in a UE. In some embodiments, the receive path 450 is configured for decoding of low-density parity check codes as described in embodiments of the present disclosure. For example, embodiments of decoding of low-density parity check codes as described herein may be implemented in connection with channel decoding and demodulation 480 depicted in FIG. 4B.

As illustrated in FIG. 4A, the transmit path 400 includes a channel coding and modulation block 405, a serial-to-parallel (S-to-P) block 410, a size N Inverse Fast Fourier Transform (IFFT) block 415, a parallel-to-serial (P-to-S) block 420, an add cyclic prefix block 425, and an up-converter (UC) 430. The receive path 450 includes a down-converter (DC) 455, a remove cyclic prefix block 460, a S-to-P block 465, a size N Fast Fourier Transform (FFT) block 470, a parallel-to-serial (P-to-S) block 475, and a channel decoding and demodulation block 480.

In the transmit path 400, the channel coding and modulation block 405 receives a set of information bits, applies coding (such as a low-density parity check (LDPC) coding), and modulates the input bits (such as with Quadrature Phase Shift Keying (QPSK) or Quadrature Amplitude Modulation (QAM)) to generate a sequence of frequency-domain modulation symbols. The serial-to-parallel block 410 converts (such as de-multiplexes) the serial modulated symbols to parallel data in order to generate N parallel symbol streams, where N is the IFFT/FFT size used in the gNB 102 and the UE 116. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to a RF frequency for transmission via a wireless channel. The signal may also be filtered at a baseband before conversion to the RF frequency.

As illustrated in FIG. 4B, the down-converter 455 down-converts the received signal to a baseband frequency, and the remove cyclic prefix block 460 removes the cyclic prefix to generate a serial time-domain baseband signal. The serial-to-parallel block 465 converts the time-domain baseband signal to parallel time-domain signals. The size N FFT block 470 performs an FFT algorithm to generate N parallel frequency-domain signals. The (P-to-S) block 475 converts the parallel frequency-domain signals to a sequence of modulated data symbols. The channel decoding and demodulation block 480 demodulates and decodes the modulated symbols to recover the original input data stream.

Each of the gNBs 101-103 may implement a transmit path 400 that is analogous to transmitting in the downlink to UEs 111-116 and may implement a receive path 450 that is analogous to receiving in the uplink from UEs 111-116. Similarly, each of UEs 111-116 may implement a transmit path 400 for transmitting in the uplink to gNBs 101-103 and may implement a receive path 450 for receiving in the downlink from gNBs 101-103.

Each of the components in FIGS. 4A and 4B can be implemented using only hardware or using a combination of hardware and software/firmware. As a particular example, at least some of the components in FIGS. 4A and 4B may be implemented in software, while other components may be implemented by configurable hardware or a mixture of software and configurable hardware. For instance, the FFT block 470 and the IFFT block 415 may be implemented as configurable software algorithms, where the value of size N may be modified according to the implementation.

Furthermore, although described as using FFT and IFFT, this is by way of illustration only and should not be construed to limit the scope of the present disclosure. Other types of transforms, such as Discrete Fourier Transform (DFT) and Inverse Discrete Fourier Transform (IDFT) functions, can be used. It will be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIGS. 4A and 4B illustrate examples of wireless transmit and receive paths 400 and 450, respectively, various changes may be made to FIGS. 4A and 4B. For example, various components in FIGS. 4A and 4B can be combined, further subdivided, or omitted and additional components can be added according to particular needs. Also, FIGS. 4A and 4B are meant to illustrate examples of the types of transmit and receive paths that can be used in a wireless network. Any other suitable architectures can be used to support wireless communications in a wireless network.

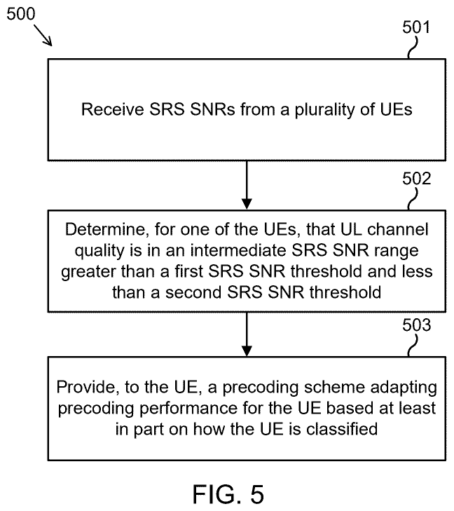

FIG. 5 illustrates a flowchart of an example procedure 500 for adaptive precoding according to embodiments of the present disclosure. For example, procedure 500 for adaptive precoding can be performed by one or more of the UE 116, the gNB 102, and/or network 130 in the wireless network 100 of FIG. 1, operating in conjunction with each other. This example is for illustration only and other embodiments can be used without departing from the scope of the present disclosure.

The procedure 500 begins with receiving SRS SNRs from a plurality of UEs (step 501). The UEs may be classified according to the SRS SNRs, with one or more of the UEs identified as benefitting from a wideband averaging of channels. For example, the UL channel quality for the one or more UEs may be determined to fall within an intermediate SRS SNR range that is greater than a first SRS SNR threshold and less than a second SRS SNR threshold (step 502). Precoding performance for those UEs is improvable over SRS-based RB/RBG level precoding, which may be employed for UEs with SRS SNR equal to or greater than the second SRS SNR threshold, or wideband PMI-based precoding, which may be employed for UEs with SRS SNR equal to or lower than the first SRS SNR threshold. The UEs with an intermediate SRS SNR may benefit from wideband channel computations of at least one of eigen vectors for a channel representation or signal-to-leakage-and-noise ratio (SLNR) for a channel, described in further detail below. Those UEs are provided with a precoding scheme adapting precoding performance based at least in part on how the UE is classified (step 503). The precoding scheme may be based on the wideband channel computations mentioned above. Further the precoding scheme preferably orthogonalized precoders. For example, ZF precoding may be employed to orthogonalize the precoders.

Although FIG. 5 illustrates one example of a process 500 for adaptive precoding, various changes may be made to FIG. 5. For example, while shown as a series of steps, various steps in FIG. 5 could overlap, occur in parallel, occur in a different order, or occur any number of times (including zero times).

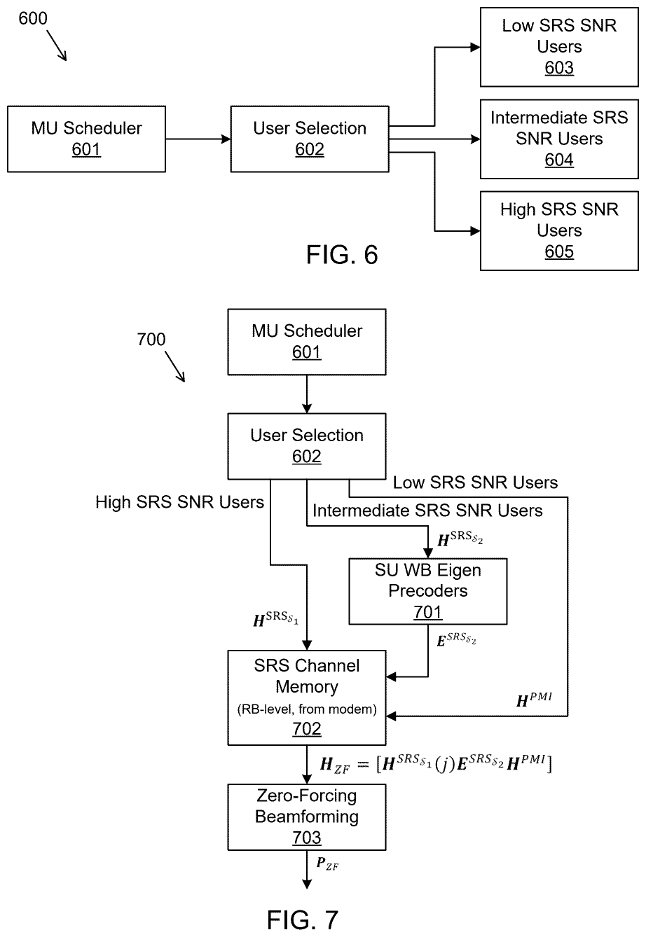

FIG. 6 is a block diagram of a multi-user subspace precoding architecture 600 for use with adaptive sub-band eigen precoding according to embodiments of the present disclosure. The architecture 600 illustrated in FIG. 6 is for illustration only, and may be implemented in (for example) base station 102 and/or the network 130. However, FIG. 6 does not limit the scope of this disclosure to any particular implementation of a system or architecture.

Consider a multiuser (MU) scenario with K users in a cell to be served at a particular time simultaneously. The received signal at the k^{th} UE is given as

$${y}^{k} = {H}^{k} {P}^{k} {x}^{k} + {\sum }_{j} {H}^{k} {P}^{j \neq k} {x}^{k} + {z}^{k} ,$$

where y^{k} is the received signal, H^{k} represents the downlink channel between the UE and the BS, P^{k}:Nₜₓ×r×N_{RBG} is the transmit precoder, assuming the rank of the channel as r, for each of the users (Nₜₓ) and for each RBG (N_{RBG}), as a function of the CSI received, x^{k} is the transmitted signal, j is an index for the UEs associated with the K users, and z^{k} is the Gaussian noise.

In some current implementations, there are typically two sources of CSI—i.e., the uplink sounding reference signal (SRS) and the precoder matrix indicator (PMI). The scheduler divides the users into two pools according to the CSI availability and the noise level of the uplink namely, an SRS user pool for high SRS SNR users and a PMI user pool for low SNR users. The channels of the users from both the pools are put into the zero forcing (ZF) function to obtain the final precoders.

In one embodiment of the present disclosure, an intermediate division of users (a separate pool for medium SRS SNR users) is introduced in the architecture 600 to separate out users with SRS SNR that is neither too high nor low. In such UEs, a different way to process the available CSI and a separate precoding algorithm to determine the precoders for these users are employed. The pool of users that are scheduled are divided into three different groups as shown in FIG. 6, and different precoding methodologies are employed for each of these groups to improve overall sumrate. The MU scheduler 601 performs user selection 602 based on low SRS SNR users 603, intermediate SRS SNR users 604, and high SRS SNR users 605. The user pool is thus segregated by the MU scheduler 601 into three different groups based on the SRS SNR, which are then subjected to different CSI processing and precoding algorithms.

Although FIG. 6 illustrates one example of a multi-user subspace precoding architecture for use with adaptive sub-band eigen precoding, various changes may be made to FIG. 6. For example, various components in FIG. 6 could be combined, further subdivided, or omitted and additional components could be added according to particular needs.

FIG. 7 is a block diagram of multi-user precoder architecture demonstrating the preprocessing of CSI of intermediate SRS SNR users, with subsequent use of the pre-processed CSI for generating precoders, according to embodiments of the present disclosure. The architecture 700 illustrated in FIG. 7 is for illustration only, and may be implemented in (for example) base station 102 and/or the network 130. However, FIG. 7 does not limit the scope of this disclosure to any particular implementation of a system or architecture.

In one embodiment, the preprocessing of the CSI of the mid-level (intermediate) SRS SNR users 604 considers the correlation among the channel at different resource block groups (RBGs) to denoise the channel at each RBG. Wideband CSI for Medium SRS SNR users.

Consider the uplink CSI from K users in the channel which are divided into three sets:
a) SR [symbol] : Set of users with high SRS SNR where channel state for the RBG level SRS, [symbol] , is good enough for the computation of the precoders.
b) SR [symbol] : Set of users with intermediate SRS SNR where the estimated uplink CSI [symbol] is further processed to denoise the SRS and then passed over for precoder computation.
c) PMI: Set of users with low SRS SNR, for which using the wideband PMI (H^{PMI}) to compute the precoder is considered preferable.

For the intermediate users of the set SR [symbol] , the channels [symbol] are processed to obtain a denoised version of the channel [symbol] as shown in FIG. 7, which is obtained as:

$${E}^{{SRS}_{{δ}_{2}}} = E i g ( {\sum }_{j} ( {H}^{{SRS}_{{δ}_{2}}} ( j ) {{H}^{{SRS}_{{δ}_{2}}} ( j )}^{H} ) ) , \qquad ( 1 )$$

where (·)^{H} is the Hermitian transpose of the channel at every RB and Eig returns a vector of the eigenvalues of the matrix. This operation captures the spatial information in the channel by averaging the channels over the frequency domain and, in the process, denoising the channel of noise.

In one embodiment combining subspace and zero forcing precoding, the precoders for every RBG, in the multiuser scenario, are computed for storage in memory 702 using the SRS channel for high SNR users, PMI for the low SNR users, and wideband eigen vectors for the intermediate SRS SNR users.

Consider a multiuser scenario where users are spread out in the cell at different distances from the cell center, therefore experiencing different path loss factor(s). The type of CSI that is used for the precoders are decided based on the SRS SNR. The channel CSI that is passed on to the zero forcing precoder generation 703 is given as

$${H}_{ZF} = [ {H}^{{SRS}_{{δ}_{1}}} ( j ) {E}^{{SRS}_{{δ}_{2}}} {H}^{PMI} ] ,$$

where [symbol] (j) is the channel of the UEs in the set SR [symbol] , [symbol] is the eigen vectors of the channel of the intermediate users, and H^{PMI} is the wideband PMI for the PMI users. The final precoders P_{ZF} are then obtained from the output of the ZF precoder generation 703.

Although FIG. 7 illustrates one example of a multi-user precoder architecture demonstrating the preprocessing of CSI of intermediate SRS SNR users, and the subsequent use for generating the precoders, various changes may be made to FIG. 7. For example, various components in FIG. 7 could be combined, further subdivided, or omitted and additional components could be added according to particular needs.

In one embodiment including adaptive sub-band Eigen precoding, the CSI processing for the intermediate SRS SNR users is done in an adaptive manner, so as to denoise the SRS while preserving the channel information such that the resulting precoders have superior performance over using noisy SRS or fully averaged wideband CSI.

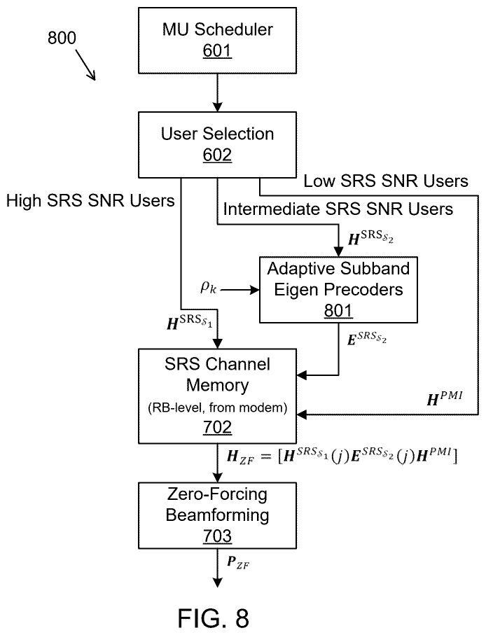

FIG. 8 is a block diagram of an alternative multi-user precoder architecture demonstrating the preprocessing of CSI of intermediate SRS SNR users, with subsequent use of the pre-processed CSI for generating precoders, according to embodiments of the present disclosure. The architecture 800 illustrated in FIG. 8 is for illustration only, and may be implemented in (for example) base station 102 and/or the network 130. However, FIG. 8 does not limit the scope of this disclosure to any particular implementation of a system or architecture.

FIG. 8 depicts a MU architecture showing the adaptive sub-band eigen precoding block that obtains the dominant vectors by averaging a certain number of RBs. ρₖ is the SRS SNR of the user k. In the multi-user scenario, the intermediate SRS SNR users have noisy SRS as CSI which may need to be further processed to be suitable for computing the precoders. In the adaptive sub-band eigen precoding 801 shown in FIG. 8, the input CSI [symbol] is fed into the block and the channel is averaged over the frequency RBs, where the number of RBs over which the channels are averaged is specific to each UE and is a function of the SRS SNR of the UE, expressed as

$${E}^{k ∈ {SRS}_{{δ}_{2}}} = Eig ( {\sum }_{j = 1}^{{η}^{k}} {H}^{k ∈ {SRS}_{{δ}_{2}}} ( j ) {{H}^{k ∈ {SRS}_{{δ}_{2}}} ( j )}^{H} ) ,$$

where ρ^{k} is the number of RBs that are averaged to get an improved version of the CSI that results in a better precoder for the intermediate SRS SNR users, k∈SRS [symbol] . The value of ρ^{k} can be determined for each UE specifically and is obtained as function of the SRS SNR of the UE.

In another embodiment, a threshold is defined in terms of the SRS SNR, where all intermediate SRS SNR users with SNR greater than the threshold are averaged over a fixed number of RBs while the users whose SRS SNR is less than the threshold, the averaging is done over all the RBs in the channel.

Although FIG. 8 illustrates one example of a multi-user precoder architecture demonstrating the preprocessing of CSI of intermediate SRS SNR users, and the subsequent use for generating the precoders, various changes may be made to FIG. 8. For example, various components in FIG. 8 could be combined, further subdivided, or omitted and additional components could be added according to particular needs.

In one embodiment employing signal-to-leakage-and-noise-ratio (SLNR)-based channel representations for intermediate users, the channel from the intermediate SRS SNR users is used in an SLNR maximization optimization to obtain precoders in the null space of the channels of the high and low SNR users.

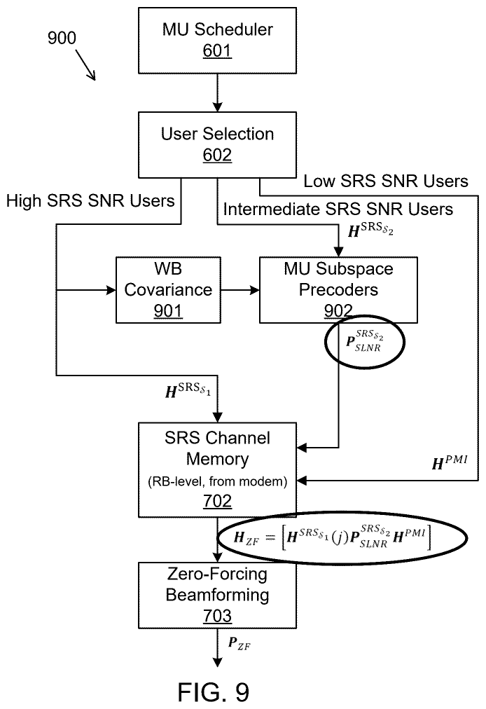

FIG. 9 is a block diagram of a multi-user precoder architecture using SLNR maximization optimization of the medium SRS SNR users, and then sending the resulting precoders as CSI to the ZF precoder, according to embodiments of the present disclosure. The architecture 900 illustrated in FIG. 9 is for illustration only, and may be implemented in (for example) base station 102 and/or the network 130. However, FIG. 9 does not limit the scope of this disclosure to any particular implementation of a system or architecture.

FIG. 9 is a multi-user precoder architecture that uses SLNR maximization optimization for the medium SRS SNR users, and then sends the resulting precoders as CSI to the ZF precoder algorithm along with the CSI from other two sets of users. Consider a multiuser scenario with users having varying SRS SNR. For users with medium SRS SNR, the channels representation

[symbol]

is used to compute the precoders as

$${P}_{SLNR}^{k} ( {N}_{Tx} \times {RI}^{k} ) = arg {max}_{P} \frac{Tr \{ {P}^{H} {R}^{k} P \}}{Tr {\{ {P}^{H} ( {R}^{{SRS}_{{δ}_{1}}} + {R}^{PMI} + {σ}^{2} I ) P \}}^{′}}$$

where R^{k} is the covariance of the desired channel and RI^{k} is the rank indicator of the user k∈SRS [symbol] , R^{PMI} is the summed covariance of all users in the set PMI, and [symbol] is the summed covariance of all the users in the set SR [symbol] . Tr finds the trace of a matrix (i.e., the sum of the diagonal elements of a matrix), while arg max returns the argument that finds the maximum value.

The precoders

$${P}_{SLNR}^{k}$$

∀k∈SR [symbol] (i.e.,

$${P}_{SLNR}^{{SRS}_{{δ}_{2}}} )$$

are subsequently used as channel representations in memory 702 for the intermediate SRS SNR users, for the zero-forcing (ZF) precoder generation. Thus, the final input to the ZF precoders 703 is given as

$${H}_{ZF} = [ {H}^{{SRS}_{{δ}_{1}}} ( j ) {P}_{SLNR}^{{SRS}_{{δ}_{2}}} {H}^{PMI} ] .$$

The final precoders P_{ZF} are the obtained from the ZF precoders 703.

Although FIG. 9 illustrates one example of a multi-user precoder architecture using SLNR maximization optimization of the medium SRS SNR users, various changes may be made to FIG. 9. For example, various components in FIG. 9 could be combined, further subdivided, or omitted and additional components could be added according to particular needs.

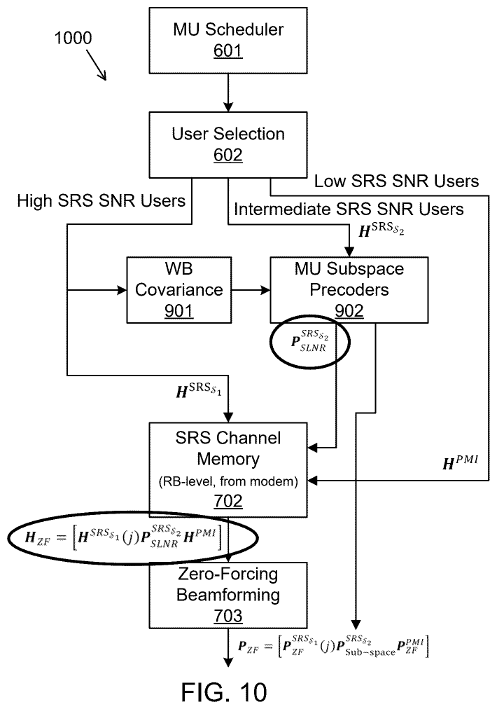

FIG. 10 is a block diagram of an alternative multi-user precoder architecture using SLNR maximization optimization of the medium SRS SNR users, and then sending the resulting precoders as CSI to the ZF precoder, according to embodiments of the present disclosure. The architecture 1000 illustrated in FIG. 10 is for illustration only, and may be implemented in (for example) base station 102 and/or the network 130. However, FIG. 10 does not limit the scope of this disclosure to any particular implementation of a system or architecture.

FIG. 10 illustrates MU SLNR-based computation of the MU precoders for medium SRS SNR users, replacing those computed from the ZF precoding in the final precoders. The SLNR precoders are computed in the null space of the high and low SNR users. In one embodiment in which SLNR-based channel representations for intermediate users are employed alongside original precoders, a variation of FIG. 9 uses the precoders that are generated from the SLNR maximization optimization as the final precoder. In architecture in FIG. 10, user classification into three sets (with high SRS SNR users which use the RB level SRS SNR, the low SRS SNR users which use WB PMI as the CSI, and the medium SRS SNR users), the high and low SRS SNR users are directly input as the CSI into the ZF precoding algorithms, and the generated precoders based therein are used for final operation. The input to the ZF precoding generation is given as

$${H}_{ZF} = [ {H}^{{SRS}_{{δ}_{1}}} ( j ) {P}_{SLNR}^{{SRS}_{{δ}_{2}}} {H}^{PMI} ] .$$

However, the final precoder output for user K is modified and is given as

$$P = [ {P}_{ZF}^{{SRS}_{{δ}_{1}}} {P}_{SLNR}^{{SRS}_{{δ}_{2}}} {P}_{ZF}^{PMI} ] ,$$

where

$${P}_{ZF}^{{SRS}_{{δ}_{1}}} and {P}_{ZF}^{PMI}$$

are from the output of the ZF precoder 703, while

$${P}_{SLNR}^{{SRS}_{{δ}_{2}}}$$

(the precoders for the users in the set SR [symbol] ) are replaced by values computed in the SLNR computation 902 as shown in FIG. 10.

Although FIG. 10 illustrates another example of a multi-user precoder architecture using SLNR maximization optimization of the medium SRS SNR users, various changes may be made to FIG. 10. For example, various components in FIG. 10 could be combined, further subdivided, or omitted and additional components could be added according to particular needs.

Any of the above variation embodiments can be utilized independently or in combination with at least one other variation embodiment. The above flowchart illustrates example methods that can be implemented in accordance with the principles of the present disclosure and various changes could be made to the methods illustrated in the flowchart herein. For example, while shown as a series of steps, various steps in each figure could overlap, occur in parallel, occur in a different order, or occur multiple times. In another example, steps may be omitted or replaced by other steps.

Although the present disclosure has been described with exemplary embodiments, various changes and modifications may be suggested to one skilled in the art. It is intended that the present disclosure encompass such changes and modifications as fall within the scope of the appended claims. None of the descriptions in this application should be read as implying that any particular element, step, or function is an essential element that must be included in the claims scope. The scope of patented subject matter is defined by the claims.

What is claimed is:

1. A method comprising:
determining when uplink (UL) channel quality for a channel for a user equipment (UE) is in an intermediate sounding reference signal (SRS) signal-to-noise ratio (SNR) range that is greater than a first SRS SNR threshold and less than a second SRS SNR threshold, wherein precoding performance for the UE is improvable by wideband channel computations of at least one of eigen vectors for a channel representation or signal-to-leakage-and-noise ratio (SLNR) for a channel; and
providing, to the UE, a precoding scheme adapting precoding performance for the UE based at least in part on how the UE is classified, when the UL channel quality is in the intermediate SNR range instead of within a range above the second SRS SNR threshold or a range below the first SRS SNR threshold.

2. The method of claim 1, wherein providing a precoding scheme further comprises:
indicating precoders for multiple user (MU) operation of the UE with other UEs that orthogonalize precoder subspaces of each subset of UEs within the range above the second SRS SNR threshold, within the intermediate range, or within the range below the first SRS SNR threshold.

3. The method of claim 2, wherein the precoder subspaces are orthogonalized by zero forcing (ZF) precoding.

4. The method of claim 1, wherein the precoding scheme adapting precoding performance for the UE comprises a sub-band eigen precoding scheme that reduces interference caused by a transmission of the UE with reception by other UEs.

5. The method of claim 4, wherein the sub-band eigen precoding scheme is an adaptive sub-band eigen precoding scheme.

6. The method of claim 1, wherein the precoding scheme adapting precoding performance for the UE comprises an SLNR precoding scheme optimizing SLNR for transmission of the UE relative to transmissions other UEs.

7. The method of claim 6, wherein a precoder determined based on the SLNR precoding scheme is combined with zero forcing (ZF) precoders for UEs within the range above the second SRS SNR threshold and ZF precoders for UEs within the range below the first SRS SNR threshold.

8. A base station apparatus in a communication system, the base station apparatus comprising:
a transceiver configured to receive sounding reference signals (SRSs) from a plurality of user equipments (UEs) served by the base station apparatus; and
at least one processing device coupled to the transceiver and configured to
determine when uplink (UL) channel quality for a channel for a user equipment (UE) is in an intermediate sounding reference signal (SRS) signal-to-noise ratio (SNR) range that is greater than a first SRS SNR threshold and less than a second SRS SNR threshold, wherein precoding performance for the UE is improvable by wideband channel computations of at least one of eigen vectors for a channel representation or signal-to-leakage-and-noise ratio (SLNR) for a channel, and
provide a precoding scheme adapting precoding performance for the UE based at least in part on how the UE is classified, when the UL channel quality is in the intermediate SNR range instead of within a range above the second SRS SNR threshold or a range below the first SRS SNR threshold.

9. The base station apparatus of claim 8, wherein the at least one processing device is configured to provide a precoding scheme by:
indicating, to the UE, precoders for multiple user (MU) operation of the UE with other UEs that orthogonalize precoder subspaces of each subset of UEs within the range above the second SRS SNR threshold, within the intermediate range, or within the range below the first SRS SNR threshold.

10. The base station apparatus of claim 9, wherein the precoder subspaces are orthogonalized by zero forcing (ZF) precoding.

11. The base station apparatus of claim 8, wherein the precoding scheme adapting precoding performance for the UE comprises a sub-band eigen precoding scheme that reduces interference caused by a transmission of the UE with reception by other UEs.

12. The base station apparatus of claim 11, wherein the sub-band eigen precoding scheme is an adaptive sub-band eigen precoding scheme.

13. The base station apparatus of claim 8, wherein the precoding scheme adapting precoding performance for the UE comprises an SLNR precoding scheme optimizing SLNR for transmission of the UE relative to transmissions other UEs.

14. The base station apparatus of claim 13, wherein a precoder determined based on the SLNR precoding scheme is combined with zero forcing (ZF) precoders for UEs within the range above the second SRS SNR threshold and ZF precoders for UEs within the range below the first SRS SNR threshold.

15. A user equipment (UE) apparatus in a communication system, the UE apparatus comprising:
a transceiver configured to transmit sounding reference signals (SRSs) to a base station serving a plurality of UEs; and
at least one processing device coupled to the transceiver and configured to receive, from the base station, an indication of a precoding scheme,
wherein, when uplink (UL) channel quality for a channel for the UE is in an intermediate sounding reference signal (SRS) signal-to-noise ratio (SNR) range that is greater than a first SRS SNR threshold and less than a second SRS SNR threshold, precoding performance for the UE is improvable by wideband channel computations of at least one of eigen vectors for a channel representation or signal-to-leakage-and-noise ratio (SLNR) for a channel, and
wherein the precoding scheme adapts precoding performance for the UE based at least in part on how the UE is classified, when the UL channel quality is in the intermediate SNR range instead of within a range above the second SRS SNR threshold or a range below the first SRS SNR threshold.

16. The UE apparatus of claim 15, wherein the indication of a precoding scheme corresponds to precoders for multiple user (MU) operation of the UE with other UEs that orthogonalize precoder subspaces of each subset of UEs within the range above the second SRS SNR threshold, within the intermediate range, or within the range below the first SRS SNR threshold.

17. The UE apparatus of claim 16, wherein the precoder subspaces are orthogonalized by zero forcing (ZF) precoding.

18. The UE apparatus of claim 15, wherein the precoding scheme adapting precoding performance for the UE comprises a sub-band eigen precoding scheme that reduces interference caused by a transmission of the UE with reception by other UEs.

19. The UE apparatus of claim 18, wherein the sub-band eigen precoding scheme is an adaptive sub-band eigen precoding scheme.

20. The UE apparatus of claim 15, wherein the precoding scheme adapting precoding performance for the UE comprises an SLNR precoding scheme optimizing SLNR for transmission of the UE relative to transmissions other UEs.
